(19) United States
(12) Patent Application Publication
(10) Pub. No.: US 2012/0310606 A1
(43) Pub. Date: Dec. 6, 2012

(54) Systems And Methods For Visualizing Building Architectures And Applications Thereof

(76) Inventor: George P. Cragg, North Vancouver (CA)

(21) Appl. No.: 13/488,372

(22) Filed: Jun. 4, 2012

Related U.S. Application Data
(60) Provisional application No. 61/493,353, filed on Jun. 3, 2011.

(51) Int. Cl. G06F 17/50

(52) U.S. Cl. 703/1

(57) ABSTRACT

The present invention provides tools for 2-D and 3-D visualization of exterior and interior environment information based on the architecture of buildings. Applications of the visualization are also described, including, for example, gaming applications and emergency response applications.

### CITATION TO RELATED APPLICATIONS

This application claims priority to U.S. Provisional Application No. 61/493,353, filed Jun. 3, 2011, the disclosure of which is incorporated herein in its entirety.

### FIELD

The present invention is related to systems and devices for improving emergency response by providing exterior and interior environmental information to first responders and gaming applications using the same information.

### BACKGROUND OF THE INVENTION

Intelligent management of safety and access control issues is becoming increasingly important for all types of public and private facilities. First responders on the scene of an emergency such as a fire must quickly assess the most critical fireground factors in deciding how most effectively to deploy fire fighters, attack the fire, rescue victims and preserve property. Efforts must continue throughout the operation to update and improve upon initial information relating to these factors. Fireground factor information comes from three broad sources: visual, reconnaissance and preplanning. Currently, reconnaissance typically involves sending someone into the structure to report on conditions as they are encountered. First responders currently have no detailed information about the architecture of the building available at the scene of the emergency.

In its NCSTAR 1: Federal Building and Fire Safety Investigation of the World Trade Center Disaster: Final Report of the National Construction Safety Team on the Collapses of the World Trade Center Tower, NIST recommended (recommendations 13, 14 and 23):

(1) That fire alarm and communications systems in buildings be developed to provide continuous, reliable, and accurate information on the status of life safety conditions at a level of detail sufficient to manage the evacuation process in building fire emergencies; (2) That control panels at fire/emergency command stations in buildings be adapted to accept and interpret a larger quantity of more reliable information from the active fire protection systems that provide tactical decision aids to fire-ground commanders; and (3) The establishment and implementation of detailed procedures and methods for gathering, processing, and delivering critical information through integration of relevant voice, video, graphical, and written data to enhance the situational awareness of all emergency responders. The systems and methods currently used by fire fighters fail meet the NIST recommendations.

Currently, fire fighters commonly wear Personal Alarm Safety Systems (PASS) warning devices which are audible warning devices designed to activate if a fire fighter remains motionless for a significant period of time. Existing PASS systems have many problems, however, and, as described above, do not provide information about the architecture of the building.

### SUMMARY OF THE INVENTIONS

The present disclosure describes systems and methods that generate 2-D and/or 3-D virtualization of a building architecture based on blueprints.

The present disclosure also provides systems and methods that deliver 2-D and/or 3-D virtualization of a building architecture generated based on blueprints to a first responder.

The present disclosure also provides systems and methods that deliver a gaming application using 2-D and/or 3-D virtualization of a building architecture generated based on blueprints.

In one particular embodiment, the present disclosure describes a method or system which may comprise the steps of, or means for, the following: scanning a tangible document comprising a blueprint for a building structure, thereby producing a two-dimensional digital representation of the building structure within a digital electronic device; identifying within the digital representation of the building structure a plurality of first features representing walls within the building structure; creating one or more first data structures representing said plurality of first features, wherein said one or more data structures contain data reflecting the size, location, and orientation of each represented wall; identifying within the digital representation of the building structure one or more second features representing doors, entryways, passages, or windows within the building structure; creating one or more second data structures representing said one or more second features, wherein said one or more second data structures contain data reflecting the location of each represented doors, entryways, passages, or windows; creating one or more third data structures representing one or more emergency features selected from the group consisting of water shut off valves, natural gas shut off valves, electrical panels, electrical shut-off switches, machinery shut-off switches, and sprinkler system connections, wherein said one or more third data structures contain data reflecting the location of said one or more emergency features within the building structure; and storing the first data structures, second data structures, and third data structures within a digital medium.

In a preferred embodiment, this method or system may further comprise the steps of, or means for, on a pixel-based electronic display device, producing an interactive visual representation comprising: one or more first graphical representations of said one or more first data structures; one or more second graphical representations of said one or more second data structures; one or more third graphical representations of said one or more third data structures; and one or more fourth graphical representations of one or more structures external to the building structure, wherein said one or more fourth representations are constructed from map data received from an online digital map service; wherein said first, second, and third representations are visually distinct.

In an even more preferred embodiment, the method further may comprise the steps of, or means for, updating the point of view within the first person, three-dimensional virtual environment in real time based on input from a game controller; wherein the interactive visual representation is a first person, three-dimensional virtual environment, and wherein said first, second, and third representations are each three-dimensional polygon models.

The interactive visual representation may also comprise a fifth representation of the location of a device comprising a positioning system.

Additional aspects of the present invention will be apparent in view of the description which follows.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a schematic diagram of a network system according to one embodiment of the invention;

FIG. 2 is a flow diagram of a process according to one embodiment of the invention; and

FIG. 3 is a block diagram of an exemplary computer system according to one embodiment of the invention.

### DETAILED DESCRIPTION OF THE INVENTION

Embodiments of the present invention are described herein in the context of a method, system and apparatus for 2-D and/or 3-D visualization of exterior and interior environment information based on the architecture of buildings and applications thereof, including, for example, emergency response applications, gaming applications, and the like. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

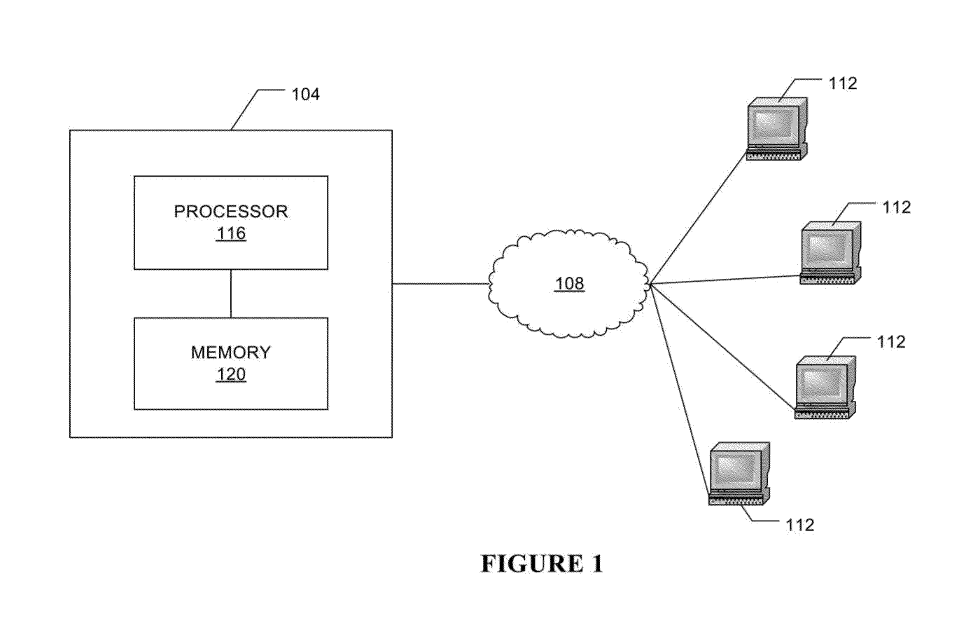

An embodiment of the invention will now be described in detail with reference to FIG. 1. FIG. 1 illustrates a web-based system 100 for delivering content to a user. The system 100 includes a host site 104 and a plurality of user systems 112 coupled via a network 108. The system 104 includes a server 116 and memory 120.

The host site 104 is connected to the plurality of user systems 112 over the network 108. The server 116 is in communication with the memory 120. The system 104 is typically a computer system, and may be an HTTP (Hypertext Transfer Protocol) server (e.g., an Apache server). The memory 120 includes storage media, which may be volatile or non-volatile memory that includes, for example, read only memory (ROM), random access memory (RAM), magnetic disk storage media, optical storage media, flash memory devices and zip drives.

The network 108 is a local area network (LAN), wide area network (WAN), a telephone network, such as the Public Switched Telephone Network (PSTN), an intranet, the Internet, or combinations thereof. The plurality of user systems 112 may be mainframes, minicomputers, personal computers, laptops, personal digital assistants (PDA), cell phones, and the like. The plurality of user systems 112 are characterized in that they are capable of being connected to the network 108. The plurality of user systems 112 typically include web browsers.

When a user of one of the plurality of user systems 112 requests to access the server to view search results responsive to a search query, a request is communicated to the host site 104 over the network 108. For example, a signal is transmitted from one of the user systems 112, the signal having a destination address (e.g., address representing the search results page for the web site), a request (e.g., a request to view the requested page) and a return address (e.g., address representing user system that initiated the request). The request may include a cookie that includes data identifying the user and/or the user computer. The server 116 accesses the database 120 to provide the user with the requested web page, which is communicated to the user over the network 108. For example, another signal may be transmitted that includes a destination address corresponding to the return address of the client system, and a web page responsive to the request.

Systems and methods of the invention utilize a first-person interpretation or perspective to create a full body experience which allows a user an opportunity to interact with a virtual exterior and/or interior environment of a building's architecture (i.e., a civic address). In one embodiment, this virtual information may correspond with geolocation data. In one embodiment, the environment information is available via the Internet.

Additional aspects of the present invention will be apparent in view of the description which follows.

In one particular embodiment, a tangible document comprising a blueprint for a building structure may be scanned by means known in the art, such as the use of an optical scanner or a digital camera, resulting in a two-dimensional digital representation of the building structure within a digital electronic device. In particular examples, this digital electronic device may be a portable device, or a fixed device, such as a database or cloud server. It may also be, for example, a medium such as a storage disk or solid state memory.

According to this embodiment, one or more, or a plurality, of features representing walls, doors, entryways, passages, and/or windows within the building structure may be identified within the digital representation of the building structure. This may, for example, be done by hand, or by an automated process known in the art. The result may be one or more data structures representing the size, location, and orientation of each such represented feature. Other features may also be included, such as fireplaces, vents, pipes, wiring, sprinklers, etc. In particular, emergency features may be identified and represented, such as water shut off valves, natural gas shut off valves, electrical panels, electrical shut-off switches, machinery shut-off switches, and/or sprinkler system connections.

In one embodiment, the visual representation may include a representation of the location of a device comprising a positioning system such as GPS. For example, the representation may include a humanoid figure at the virtual location of a firefighter who is carrying or wearing a GPS device which is networked with the device creating the visual representation.

Preferably, this digital representation or set of digital representations may be stored on a local or remote digital medium, such as RAM, ROM, a solid state memory, a disk drive, or a drive bank.

Preferably, on a pixel-based electronic display device, producing an interactive visual representation may be produced on a pixel-based electronic display device, such as a monitor, a heads-up display, an optical projector, etc. This visual representation may contain graphical representations of the data structures identified above, representing the walls and other features, including emergency features, of the building. Even more preferably, the representation may include graphical representations of mobile or fixed structures external to the building structure, such as roadways, sidewalks, pathways, railroad tracks, trees, grass and other plants, automobiles, swimming pools, and/or people, as well as nearby emergency features such as electrical transformers, water conduits and fire hydrants, gas and sewer conduits and/or their respective shut-off valves, power and communication lines, etc.

Data about the external environment of the building may be obtain from a number of sources, most preferably from an online digital map service such as, or similar to, Google Earth. Satellite imagery may also be used, in one embodiment.

Most preferably, the visual representation may be a three-dimensional virtual environment updated in real time, with a particular point of view which seems like the location of a camera. This type of representation is familiar in the gaming world. The point of view may be updated by any number of means known in the art, such as by the use of a game controller. In addition, the point of view may be updated by obtaining changing coordinates from a GPS or other positioning system. Preferably, the visual representations above may take the form of polygon models, ray tracing models, or other three-dimensional renderings calculated by a computer. These models may have shading and textures, and other visual features known in the art for added realism.

Preferably, the various representations discussed above will be visually distinct. For example, the walls will be distinct from the doorways and windows, to allow emergency personnel to easily distinguish between the two. Most preferably, the emergency features will stand out in a way that calls the viewer to their attention, such as by the use of a contrasting or changing color, blinking, radiant shining, or movement. Accompanying the visual representation may be audible sound cues which distinguish the object in a three-dimensional sound space, such as ringing or the use of a tone that becomes louder when the point of view is in the proximity of the object. Haptic vibration cues may also be used, such as the vibration of a controller when crossing a door or window threshold, or when walking through a wall if that is permitted, or in proximity to an emergency facility.

In one embodiment, the user can navigate through the virtual environment of the building's architecture via a simulated camera. The simulated camera allows the user to move as they desire through the building (e.g., move forward, move backward, move left, move right). In one embodiment, the 3-D model is available on Google Earth using a plug-in.

The user can also view the floor plate of the building's architecture in 2-dimensions in situ on the real property. The view can be juxtaposed with streets, lanes and neighboring properties (e.g., within Goggle Earth). The user can also maneuver freely through the floor plan as described above.

The building's blueprints may in one embodiment be used as a reference to create the floor plan in 2D. Using Unity pro and then Sketchup software allows placing of the model into the correct civic address in Goggle Earth using, for example, a “place model” command. The viewer can then geo-locate and free roam through the floor plate at that civic address.

Then, in one embodiment, push and pull technology with Modo can be used to create the walls in 3D (with windows, doors, interior walls, ceilings, floor textures, pictures, and/or light fixtures).

In one embodiment, to make the environment work interactively, a game engine web player software Unity may be used. It can work as a separate file that the user can download and make playable in their Internet browser as an interactive. Then, using a Sketchup “place model” command, the interactive model can then be plugged-in to the correct civic address in Google Earth. The user can now geo-locate and free roam through the 3D animation at the civic address.

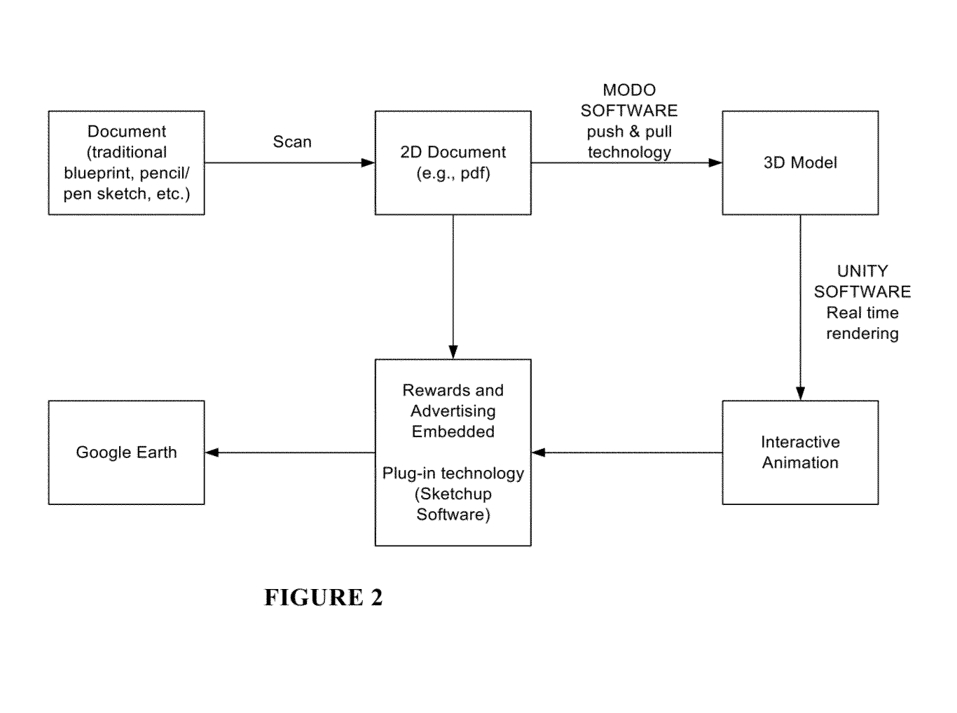

FIG. 2 illustrates a schematic flow diagram according to one embodiment of the invention. As shown in FIG. 2, the process begins with a document, such as a traditional blueprint or pencil/pen sketch. The document is then scanned to generate an electronic version of the document. The electronic version is a 2-D version of the document. A 3-D model is then generating using, for example, Modo Software, using push and pull technology. An interactive animation can be generated from the 3-D model using Unity Software, which is a real time rendering application. Rewards and advertising can be embedded into the 2D document or the 3D model. A plug-in technology, such as Sketchup Software can be used to add the 2D or 3D document to Google Earth.

In one preferred embodiment, the architecture of every or some substantial number of, civic address is archived on the Internet.

In one embodiment, the system of the present invention provides up to date information for first responders, and a reliable verifiable high level of facility visualization. It allows first responders to enter an emergency situation with more information (i.e., information about the architecture of the building using the electronic 2D document or the 3D model).

The systems and methods of the invention provide an information gateway to the emergency response industry (e.g., police, fire, ambulance, military) and/or the general public, including, for example, the insurance, construction, real estate and utility service-providing community. It facilitates web-based information management allowing the emergency managers and first responders to complete their task more efficiently, safely and effectively.

In one embodiment, the system is used as part of a computer game.

Embodiments of the invention are advantageous because they aggregate a network of architectural data with gaming animation, user interactivity and social connecting.

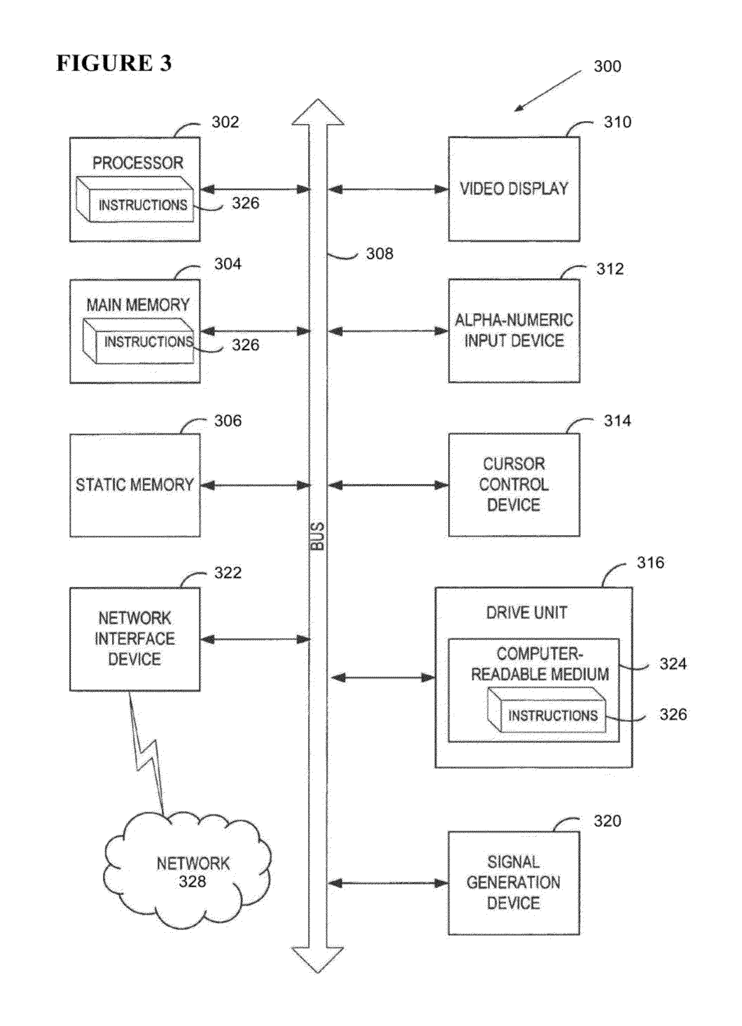

FIG. 3 shows a diagrammatic representation of machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 (e.g., read only memory (ROM), flash memory, dynamic random access memory (DRAM) such as synchronous DRAM (SDRAM) or Rambus DRAM (RDRAM), etc.) and a static memory 306 (e.g., flash memory, static random access memory (SRAM), etc.), which communicate with each other via a bus 308.

The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 320 (e.g., a speaker) and a network interface device 322.

The disk drive unit 316 includes a computer-readable medium 324 on which is stored one or more sets of instructions (e.g., software 326) embodying any one or more of the methodologies or functions described herein. The software 326 may also reside, completely or at least partially, within the main memory 304 and/or within the processor 302 during execution thereof by the computer system 300, the main memory 304 and the processor 302 also constituting computer-readable media. The software 326 may further be transmitted or received over a network 328 via the network interface device 322.

While the computer-readable medium 324 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, and optical and magnetic media.

It should be noted that the server is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices can be PCs, handsets, servers, PDAs or any other device or combination of devices which can carry out the disclosed functions in response to computer readable instructions recorded on media. The phrase “computer system”, as used herein, therefore refers to any such device or combination of such devices.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A method comprising:
scanning a tangible document comprising a blueprint for a building structure, thereby producing a two-dimensional digital representation of the building structure within a digital electronic device;
identifying within the digital representation of the building structure a plurality of first features representing walls within the building structure;
creating one or more first data structures representing said plurality of first features, wherein said one or more data structures contain data reflecting the size, location, and orientation of each represented wall;
identifying within the digital representation of the building structure one or more second features representing doors, entryways, passages, or windows within the building structure;
creating one or more second data structures representing said one or more second features, wherein said one or more second data structures contain data reflecting the location of each represented doors, entryways, passages, or windows;
creating one or more third data structures representing one or more emergency features selected from the group consisting of water shut off valves, natural gas shut off valves, electrical panels, electrical shut-off switches, machinery shut-off switches, and sprinkler system connections, wherein said one or more third data structures contain data reflecting the location of said one or more emergency features within the building structure; and
storing the first data structures, second data structures, and third data structures within a digital medium.

2. The method of claim 1, further comprising:
on a pixel-based electronic display device, producing an interactive visual representation comprising:
one or more first graphical representations of said one or more first data structures;
one or more second graphical representations of said one or more second data structures;
one or more third graphical representations of said one or more third data structures; and
one or more fourth graphical representations of one or more structures external to the building structure, wherein said one or more fourth representations are constructed from map data received from an online digital map service;
wherein said first, second, and third representations are visually distinct.

3. The method of claim 2, further comprising:
updating a point of view within a first person, three-dimensional virtual environment in real time based on input from a game controller;
wherein the three-dimensional virtual environment is the interactive visual representation, and wherein said first, second, and third representations are each three-dimensional polygon models.

4. The method of claim 2, wherein the interactive visual representation further comprises a fifth representation of the location of a device comprising a positioning system.

5. A system comprising:
a digital electronic device;
means for scanning a tangible document comprising a blueprint for a building structure, thereby producing a two-dimensional digital representation of the building structure within the digital electronic device;
means for identifying within the digital representation of the building structure a plurality of first features representing walls within the building structure;
means for creating one or more first data structures representing said plurality of first features, wherein said one or more data structures contain data reflecting the size, location, and orientation of each represented wall;
means for identifying within the digital representation of the building structure one or more second features representing doors, entryways, passages, or windows within the building structure;
means for creating one or more second data structures representing said one or more second features, wherein said one or more second data structures contain data reflecting the location of each represented doors, entryways, passages, or windows;
means for creating one or more third data structures representing one or more emergency features selected from the group consisting of water shut off valves, natural gas shut off valves, electrical panels, electrical shut-off switches, machinery shut-off switches, and sprinkler system connections, wherein said one or more third data structures contain data reflecting the location of said one or more emergency features within the building structure; and
a digital medium for storing the first data structures, second data structures, and third data structures.

6. The system of claim 5, further comprising:
a pixel-based electronic display device;
means for producing an interactive visual representation on the display device;
means for producing within the interactive visual representation one or more first graphical representations of said one or more first data structures;
means for producing within the interactive visual representation one or more second graphical representations of said one or more second data structures;
means for producing within the interactive visual representation one or more third graphical representations of said one or more third data structures; and
means for producing within the interactive visual representation one or more fourth graphical representations of one or more structures external to the building structure, wherein said one or more fourth representations are constructed from map data received from an online digital map service;
wherein said first, second, and third representations are visually distinct.

7. The system of claim 6, further comprising:
means for updating a point of view within the first person, three-dimensional virtual environment in real time based on input from a game controller;
wherein the three-dimensional virtual environment is a first person is the interactive visual representation, and wherein said first, second, and third representations are each three-dimensional polygon models.

8. The system of claim 6, further comprising means for producing within the interactive visual representation a fifth representation of the location of a device comprising a positioning system.

9. A method comprising:
on a pixel-based electronic display device, producing an interactive visual representation comprising:
one or more first graphical representations of one or more first data structures produced by (a) scanning a tangible document comprising a blueprint for a building structure, thereby producing a two-dimensional digital representation of the building structure within a digital electronic device; (b) identifying within the digital representation of the building structure a plurality of first features representing walls within the building structure; and (c) creating one or more first data structures representing said plurality of first features, wherein said one or more data structures contain data reflecting the size, location, and orientation of each represented wall;
one or more second graphical representations of one or more second data structures produced by (d) identifying within the digital representation of the building structure one or more second features representing doors, entryways, passages, or windows within the building structure; and (e) creating one or more second data structures representing said one or more second features, wherein said one or more second data structures contain data reflecting the location of each represented doors, entryways, passages, or windows;
one or more third graphical representations of one or more third data structures representing one or more emergency features selected from the group consisting of water shut off valves, natural gas shut off valves, electrical panels, electrical shut-off switches, machinery shut-off switches, and sprinkler system connections, wherein said one or more third data structures contain data reflecting the location of said one or more emergency features within the building structure; and
one or more fourth graphical representations of one or more structures external to the building structure, wherein said one or more fourth representations are constructed from map data received from an online digital map service;
wherein said first data structures, second data structures, and third data structures are stored within a digital medium; and
wherein said first, second, and third representations are visually distinct.

10. The method of claim 9, further comprising:
updating a point of view within a first person, three-dimensional virtual environment in real time based on input from a game controller;
wherein the three-dimensional virtual environment is the interactive visual representation, and wherein said first, second, and third representations are each three-dimensional polygon models.
